(19) United States
(12) Patent Application Publication
(10) Pub. No.: US 2018/0053304 A1
(43) Pub. Date: Feb. 22, 2018

(54) METHOD AND APPARATUS FOR DETECTING RELATIVE POSITIONS OF CAMERAS BASED ON SKELETON DATA

(71) Applicant: KOREA ADVANCED INSTITUTE OF SCIENCE AND TECHNOLOGY, Daejeon (KR)

(72) Inventors: Jun Yong Noh, Daejeon (KR); Jae Dong S. Kim, Daejeon (KR); Hyung Goog Seo, Daejeon (KR); Sang Hun Park, Daejeon (KR); Seung Hoon Cha, Daejeon (KR); Jung Eun Yoo, Daejeon (KR)

(21) Appl. No.: 15/291,814

(22) Filed: Oct. 12, 2016

(30) Foreign Application Priority Data
Aug. 19, 2016 (KR) 10-2016-0105635

(51) Int. Cl. G06T 7/00; H04N 13/02

(52) U.S. Cl. CPC G06T 7/0044; H04N 13/0203; G06T 2207/10012; G06T 7/003; G06T 2207/30244; H04N 13/0296

(57) ABSTRACT

Disclosed herein are a method and apparatus for detecting a relative camera position based on a skeleton data, wherein the method may include receiving skeleton information obtained using a plurality of depth cameras; detecting a position relationship between corresponding joints from the received skeleton information; and obtaining a relative position and a rotation information between the depth cameras in such a way to use a position relationship between the detected joints.

### CROSS-REFERENCE TO RELATED APPLICATION

This application claims priority of Korean Patent Application No. 10-2016-0105635, filed on Aug. 19, 2016, in the KIPO (Korean Intellectual Property Office), the disclosure of which is incorporated herein entirely by reference.

### BACKGROUND OF THE INVENTION

### Field of the Invention

The present invention relates to a method and apparatus for detecting a relative position, a rotation information, etc. between a plurality of cameras.

### Description of the Related Art

In recent years, a research on a 3D object recognition and a system implementation thereof are being widely carried out, wherein an integral technology is being used, which is able to record and recover a 3D image for the sake of a 3D object recognition.

This integral imaging technology was first proposed in 1908 by Lippmann, which is able to advantageously provide a full parallax and a continuous observation view, for example, like a holographic method corresponding to an ideal 3D display method.

The aforementioned integral imaging technology, in general, is formed of a pickup step, and a display step. More specifically, the pickup step may be implemented with a 2D detector, for example, an image sensor (CCD), and an array of lenses, wherein a 3D object may position in front of an array of the lenses. Various image information corresponding to the 3D object may pass an array of the lenses and may be stored in the 2D detector. The thusly stored images may be called elemental images, which will be used later for the reproduction of a 3D image.

The integral imaging technology is referred to a reverse procedure of the pickup step and may be implemented with a display device, for example, a LCD (Liquid Crystal Display), and an array of lenses.

More specifically, a 3D image media is referred to a new conceptual actual image media which may increase the level of visual information higher, for which it is expected that it may lead the next generation display. Since the 3D display technology is able to show, to an observer, an actual depth information that a predetermined object has in a 3D space, it is called an ultimate image implementation technology.

Meanwhile, a depth camera is referred to a camera which is able to take a picture of a depth image having a predetermined distance value to a point corresponding to each pixel of a predetermined image in the camera. Various kinds of the depth cameras are now present, which may be categorized based on the type of a distance measurement sensor, for example, a TOF (Time Of Flight), a structured light, etc.

The depth camera may be similar with a typical video camera in the point that it is able to continuously take the pictures of a forward scene in front of the camera at a constant resolution, but there is a difference since the value of each pixel has an information on a distance between a space object projected in the direction of a camera's plane and the camera, not in the form of brightness and color.

Moreover, it needs to obtain a relative position between cameras, a rotation information, etc. so as to recognize an actual space in such a way to use a plurality of depth cameras.

### SUMMARY OF THE INVENTION

The present invention are directed to providing a method and apparatus for easily detecting a position relationship between a plurality of cameras based on a skeleton data.

According to an exemplary embodiment of the present invention are directed to providing a method for detecting a relative camera position based on a skeleton data, which may include, but is not limited to, receiving skeleton information obtained using a plurality of depth cameras; detecting a position relationship between corresponding joints from the received skeleton information; and obtaining a relative position and a rotation information between the depth cameras in such a way to use a position relationship between the detected joints.

Another exemplary embodiment of the present invention provides an apparatus for detecting a relative camera position based on a skeleton data, which may include, but is not limited to, a communication unit configured to receive a skeleton information obtained using a plurality of depth cameras; a synchronizing unit configured to synchronize the received skeleton information; a joint position detection unit configured to detect a position relationship between the corresponding joints from the synchronized skeleton information; and a camera information obtaining unit configured to obtain a relative position between the depth cameras and a rotation information, in such a way to use a position relationship between the detected joints.

Meanwhile, the method for detecting a relative camera position based on a skeleton data may be implemented in the form of a computer readable recording medium on which a program executable on a computer is recorded.

According to the exemplary embodiment of the present invention, since the position between a plurality of cameras and a rotation information can be detected based on the skeleton data obtained using a plurality of depth cameras, a relative position between the depth cameras can be easily obtained for the sake of a space recognition.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a flow chart of a method for detecting a relative camera position based on a skeleton data according to an exemplary embodiment of the present invention;

FIG. 2 is a block diagram of a configuration of a system for detecting a relative camera position based on a skeleton data according to an exemplary embodiment of the present invention;

FIG. 3 is a block diagram of a configuration of an apparatus for detecting a relative camera position based on a skeleton data according to an exemplary embodiment of the present invention;

FIGS. 4 and 5 are views an exemplary embodiment of a method for detecting a position relationship between joints from a skeleton data;

FIG. 6 is a view an exemplary embodiment of a method for obtaining a position information so as to match skeleton information;

FIG. 7 is a view an exemplary embodiment of a method for obtaining a relative position between cameras and a rotation information; and

FIG. 8 is a view of examples of results of a method for detecting a relative camera position based on a skeleton data according to an exemplary embodiment of the present invention.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

The exemplary embodiment of the present invention is directed to more easily obtaining a relative position and rotation information between a plurality of cameras so as to recognize an actual space using a plurality of depth cameras, by which it is possible to recognize a wider space which was not recognized using one depth camera, in such a way to use a relative position relationship between a plurality of the depth cameras.

According to an exemplary embodiment of the present invention, the position relationship between the cameras can be obtained in such a way to draw the position relationship of each camera coordinate with respect to the same joint after the skeleton data have been concurrently obtained from a plurality of the depth cameras.

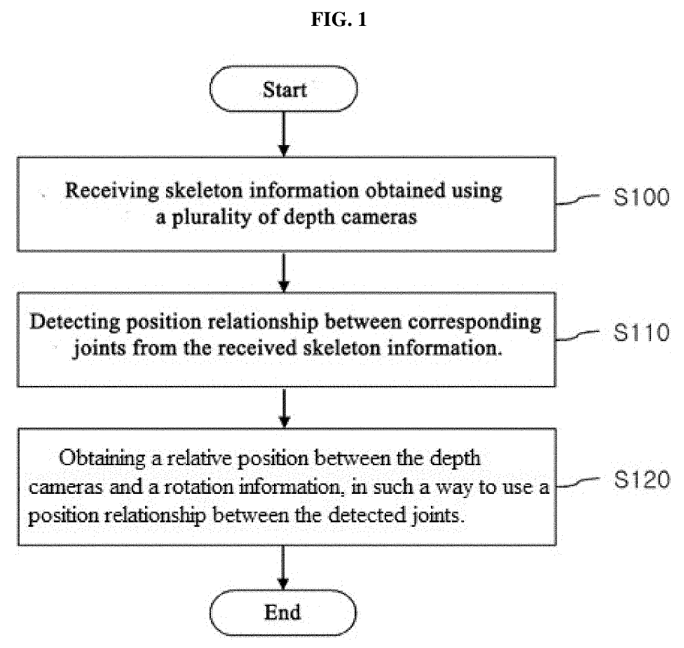

FIG. 1 is a flow chart of a method for detecting a relative camera position based on a skeleton data according to the exemplary embodiment of the present invention.

Referring to FIG. 1, the method according to the present invention may include, but is not limited to, wherein skeleton information obtained using a plurality of the depth cameras are inputted (S100), and wherein the position relationship between the corresponding joints are detected from the inputted skeleton information (S110).

Subsequently, the position relationship and rotation information between a plurality of the depth cameras can be obtained using a relative position between the detected joints (S120).

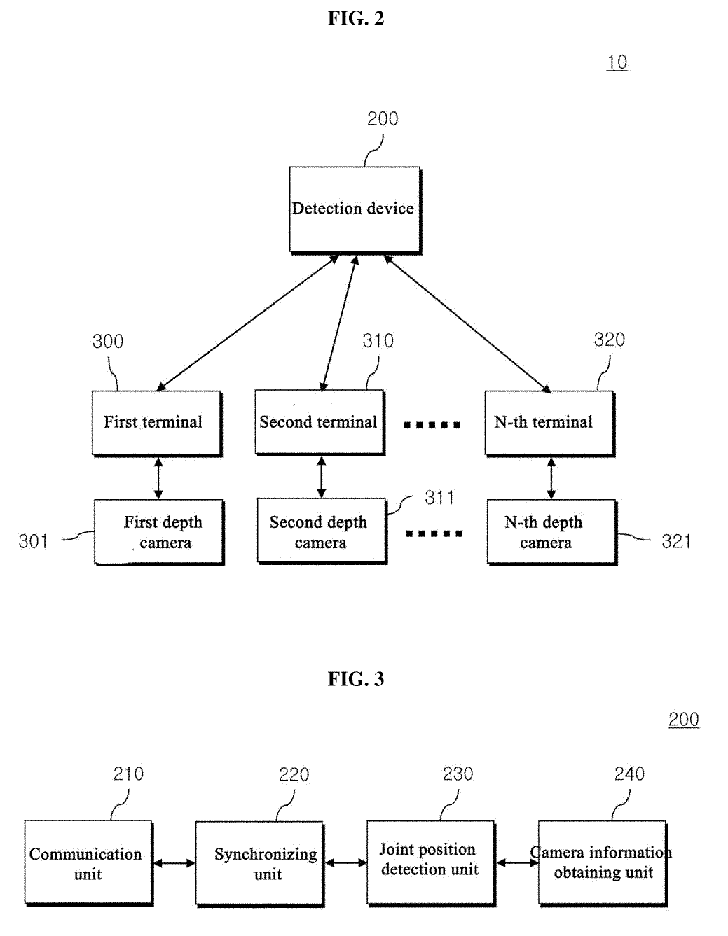

Referring to FIG. 2 to FIG. 8, the exemplary embodiments of the method and apparatus for detecting a relative camera position based on a skeleton data according to the present invention will be more specifically described.

FIG. 2 is a block diagram of a configuration of a system for detecting a relative camera position based on a skeleton data according to the exemplary embodiment of the present invention. The system 10 may include, but is not limited to, a skeleton data-based relative camera position detection device 200, a plurality of terminals 300 to 320 and a plurality of depth cameras 301 to 321.

Referring to FIG. 2, a plurality of the depth cameras 301 to 321 are connected to a plurality of the terminals 300 to 320, wherein the skeleton information obtained from each depth camera can be transmitted in real time to the terminals connected thereto.

For example, each of the depth cameras 301 to 321 may be implemented with an infrared ray camera, and each of the terminals 300 to 320 may be implemented with a PC module equipped with the infrared ray camera.

In order to secure that the skeleton information obtained from a plurality of the depth cameras 301 to 321 and transmitted to a plurality of the terminals 300 to 320 are the information obtained at the same viewpoints, a predetermined process for synchronizing the skeleton information transmitted from a plurality of the depth cameras 301 to 321 may be necessary.

For this, a plurality of the depth cameras 301 to 321 are able to transmit, in milliseconds, the skeleton information and the time information at which a corresponding information has been obtained, in such a way to use a NTP (Network Time Protocol).

A plurality of the terminals 300 to 320 and the detection device 200 which is configured to skeleton information from the terminals 300 to 320 may be configured to synchronize the skeleton information obtained from a plurality of the depth cameras 301 to 321 in such a way to use the time information.

The detection device 200 may receive from a plurality of the terminals 300 to 320 the skeleton information obtained from a plurality of the depth cameras 301 to 321 and may detect a position relationship between the corresponding joints from the received skeleton information.

More specifically, the detection device 200 may confirm if two or more than two different depth cameras have recognized the same joints in the skeletons obtained by the depth cameras 301 to 321.

Subsequently, the detection device 200 is able to obtain the position relationship between the depth cameras 301 to 321, a rotation information, etc. in such a way to use the relative positions between the same joints in the skeleton information obtained from the depth cameras 301 to 321.

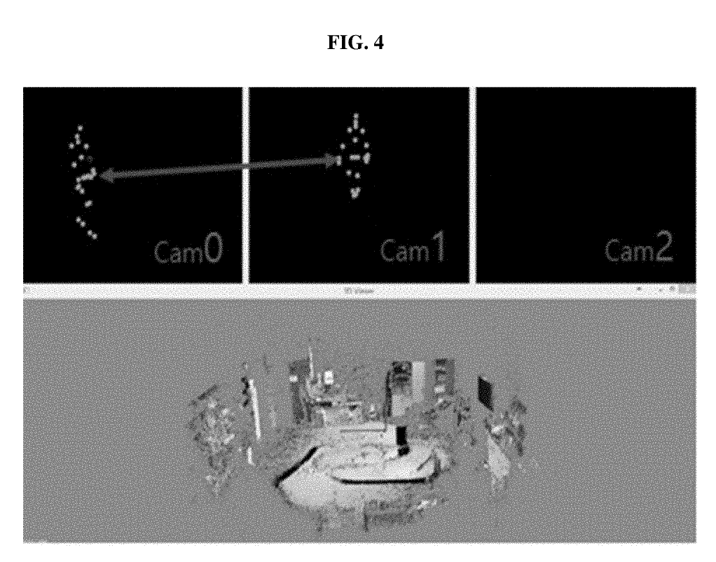

FIG. 3 is a block diagram of a configuration of an apparatus for detecting a relative camera position based on a skeleton data according to the exemplary embodiment of the present invention. The detection device 200 may include, but is not limited to, a communication unit 210, a synchronizing unit 220, a joint position detection unit 230, and a camera information obtaining unit 240.

Referring to FIG. 3, the communication unit 210 is able to receive, from a plurality of the terminals 300 to 320, the skeleton information obtained using a plurality of the depth cameras 301 to 321.

Thus, the skeleton information obtained by the depth cameras 301 to 321 may be transmitted together with the time information obtained in milliseconds and may be inputted to the detection device 200.

The synchronization unit 220 may synchronize the skeleton information obtained from the depth cameras 301 to 321 in such a way to use the obtaining time information which has been obtained together with the skeleton information.

Meanwhile, since the skeleton information obtained from a plurality of the depth cameras 301 to 321 may have errors, it need to additionally carry out a process to remove any outliers with respect to the skeleton information.

Thereafter, the joint position detection unit 230 may detect a position relationship between the corresponding joints from the skeleton information obtained from the depth cameras 301 to 321.

For example, the joint position detection unit 230 may detect a position relationship between the same joints in such a way to confirm if the same joints are present between at least two in the skeleton information obtained from the depth cameras 301 to 321.

Referring to FIG. 4, if the head joint of the user recognized by the camera number “0” among the depth cameras 301 to 321 has been recognized at the camera number “1”, the joint position detection unit 230 may calculate a correlation between the position of the head joint recognized by the camera number “0” and the position of the head joint recognized by the camera number “1”, thus obtaining an information, for example, the relative positions of the camera number ‘0” and the camera number “1” and any rotation relationship.

Meanwhile, since it is hard to correctly recognize the direction that a person is seeing (namely, it is referred if the person is seeing the camera or is standing backward), with only the skeleton information obtained from the depth cameras, the joint position detection unit 230 is able to detect the information on the direction that the person is seeing, from the skeleton information in such a way to recognize a user's face.

For example, the joint position detection unit 230 may be configured to recognize the user's left hand and right hand from the skeleton information in such a way to recognize the user's face, thus determining the position relationship between the corresponding joints by recognizing if the user is seeing a corresponding camera or is standing backward.

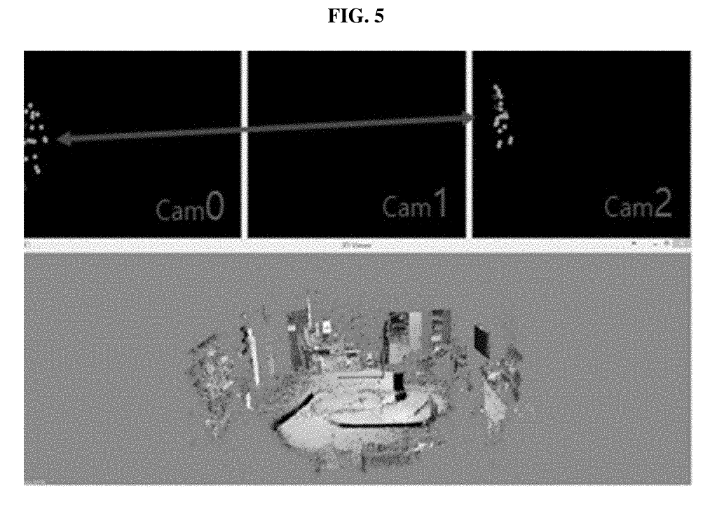

Referring to FIG. 5, if a specific joint of the user recognized by the camera number “0” among the depth cameras 301 to 321 is recognized by the camera number “2”, the joint position detection unit 230 may calculate a correlation between the position of the joint recognized by the camera number “0” and the position of the joint recognized by the camera number “2”, thus obtaining an information, for example, a relative position between the camera number “0” and the camera number “2” and the rotation relationship.

Thus, the more the position relationship information with respect to the same joints detected by the joint position detection unit 230 are available, the more accurately the position and rotation information can be detected between the depth cameras 301 to 321.

Moreover, the camera information obtaining unit 240 is able to obtain the position relationship and rotation information between the depth cameras 301 to 321 in such a way to use the relative position between the joints detected by the joint position detection unit 230.

The camera information obtaining unit 240 is able to obtain a position information to match the skeleton information obtained by the depth cameras 301 to 321 in such a way to use a rigid transformation registration method with RANSAC, by which the position and rotation information between the depth cameras 301 to 321 can be recognized.

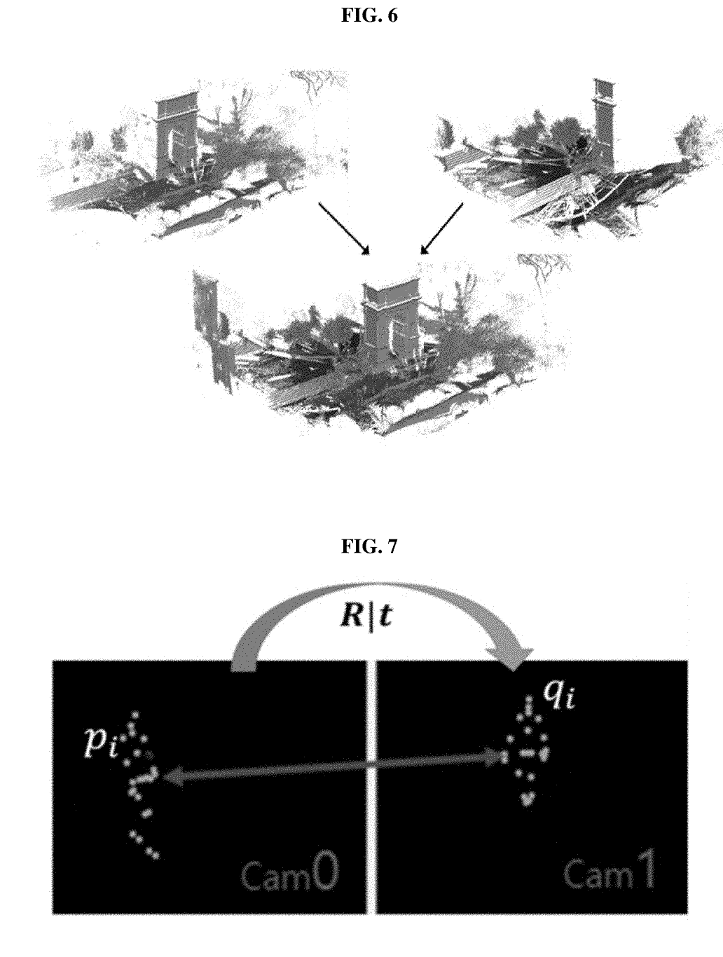

Referring to FIG. 6, the skeleton information obtained from the different depth cameras are moved to the most matching positions based on the rigid transformation registration method, so the position relationship (or the position relationship between the two corresponding depth cameras) between the two skeleton information can be obtained.

Referring to FIG. 7 and the following Equation 1, “R” represents a rotational transform matrix (3×3), and “t” represents a positional transform matrix (3×1), “n” represents the number of the skeleton points, and pᵢ and qᵢ represent the skeleton point of each depth camera.

$${argmin}_{R , t} {\sum }_{i}^{n} ‖ {p}_{i} - ( \text{Rqi} + t ) ‖ \qquad [ Equation 1 ]$$

In the case of the values “R” and “t” are obtained, the relative position and rotation relationship between the two depth cameras 301 to 321 can be obtained.

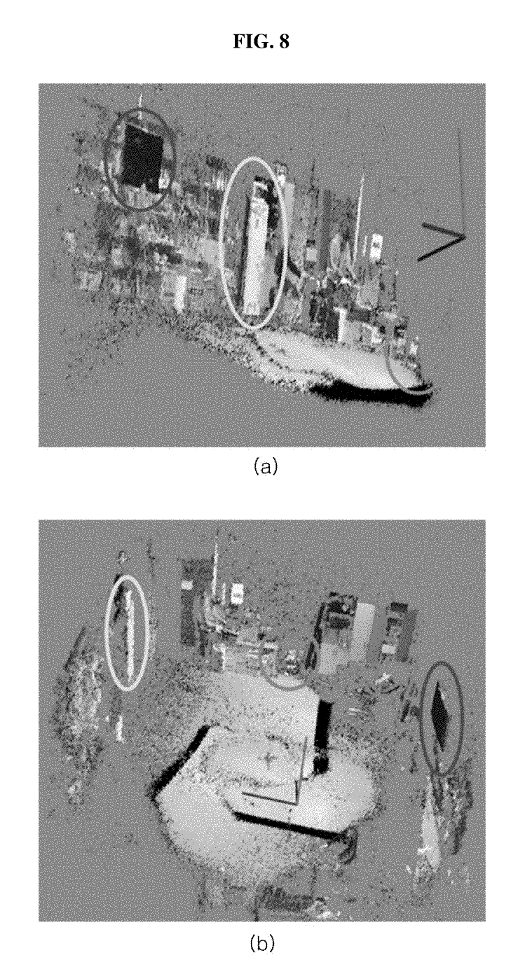

FIG. 8 is a view of an exemplary embodiments results of a method for detecting a relative camera position based on a skeleton data according to the exemplary embodiment of the present invention.

Referring to FIG. 8, it shows a result of the implementation carried out based on the method for detecting a relative camera position based on a skeleton data according to the exemplary embodiment of the present invention, wherein the relative position relationship between a plurality of the depth cameras illustrated in (b) can be obtained through the objects recognized in the images before correction as illustrated in (a).

According to the exemplary embodiment of the present invention of a method for detecting a relative camera position based on a skeleton data may be manufactured in the form of a program which is executable on a computer, and the program can be recorded on a computer readable recording medium. The computer readable recording medium may be implemented with, for example, a ROM, a RAM, a CD-ROM, a magnetic tape, a floppy disk, an optical data storage, etc. It may be implemented in the form of a carrier wave (for example, a transmission via the Internet).

The computer readable recording medium may be distributed over a computer system connected via the network, wherein the codes that the computer can read in a distribution way, may be stored and executed. Moreover, the functional programs, codes and code segments employed to implement the method of the present invention can be easily drawn by a programmer having ordinary skill in the art.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method for detecting a relative camera position based on a skeleton data, comprising:
receiving skeleton information obtained using a plurality of depth cameras;
detecting a position relationship between corresponding joints from the received skeleton information; and
obtaining a relative position and a rotation information between the depth cameras in such a way to use a position relationship between the detected joints.

2. The method of claim 1, further comprising removing an outlier with respect to the received skeleton information.

3. The method of claim 1, wherein the skeleton information is transmitted or received using a NTP (Network Time Protocol).

4. The method of claim 3, wherein the skeleton information is transmitted or received together with an information with respect to the obtained time, and the skeleton information obtained by a plurality of the depth cameras are synchronized using the obtained time information.

5. The method of claim 1, wherein the detecting includes detecting an information with respect to the direction that a user is seeing, from the received skeleton information, in such a way to recognize a user's face.

6. The method of claim 1, wherein the detecting includes confirming if the same joints are present between at least two among the received skeleton information.

7. The method of claim 6, wherein the obtaining is to obtain a relative position and a rotation information between two depth cameras corresponding to the skeleton information wherein the same joints are present.

8. The method of claim 1, wherein the obtaining includes obtaining a position information to match the skeleton information obtained using the depth cameras, in such a way to use a Rigid Transformation Registration method.

9. The method of claim 8, wherein an RANSAC algorithm is employed together during the Rigid Transformation Registration.

10. A recording medium on which a program to execute the method of claim 1 is recorded.

11. An apparatus for detecting a relative camera position based on a skeleton data, comprising:
a communication unit configured to receive a skeleton information obtained using a plurality of depth cameras;
a synchronizing unit configured to synchronize the received skeleton information;
a joint position detection unit configured to detect a position relationship between the corresponding joints from the synchronized skeleton information; and
a camera information obtaining unit configured to obtain a relative position between the depth cameras and a rotation information, in such a way to use a position relationship between the detected joints.

12. The apparatus of claim 10, further comprising an outlier removing unit configured to remove an outlier with respect to the received skeleton information.

13. The apparatus of claim 10, wherein the skeleton information is transmitted or received together with an information with respect to the obtained time, in such a way to use a NTP (Network Time Protocol).

14. The apparatus of claim 10, wherein the joint position detection unit is configured to detect an information with respect to the direction that a user is seeing, from the received skeleton information, in such a way to recognize a user's face, and to confirm if the same joints are present between at least two among the received skeleton information.

15. The apparatus of claim 10, wherein the camera information obtaining unit is configured to obtain a position information to match the skeleton information obtained using the depth cameras, in such a way to use a Rigid Transformation Registration method.

16. The method of claim 2, wherein the skeleton information is transmitted or received using a NTP (Network Time Protocol).

17. The method of claim 16, wherein the skeleton information is transmitted or received together with an information with respect to the obtained time, and the skeleton information obtained by a plurality of the depth cameras are synchronized using the obtained time information.

18. The method of claim 2, wherein the detecting includes detecting an information with respect to the direction that a user is seeing, from the received skeleton information, in such a way to recognize a user's face.

19. The method of claim 2, wherein the detecting includes confirming if the same joints are present between at least two among the received skeleton information.

20. The method of claim 2, wherein the obtaining includes obtaining a position information to match the skeleton information obtained using the depth cameras, in such a way to use a Rigid Transformation Registration method.
